(19) United States
(12) Patent Application Publication
(10) Pub. No.: US 2004/0086351 A1
(43) Pub. Date: May 6, 2004

(54) Micro-motion machine and micro-element fabricating machine using a 3 degree of freedom parallel mechanism

(76) Inventors: Jong Won Kim, Seoul (KR); Xin Jun Liu, Suwon-Si (KR); Kun-Ku Oh, Seoul (KR)

Correspondence Address: DICKSTEIN SHAPIRO MORIN & OSHINSKY LLP, 2101 L STREET NW, WASHINGTON, DC, 20037-1526, US

(21) Appl. No.: 10/329,442

(22) Filed: Dec. 27, 2002

(30) Foreign Application Priority Data
Nov. 6, 2002 (KR) 10-2002-0068549

(51) Int. Cl. B23C 1/12

(52) U.S. Cl. 409/235; 409/201; 74/490.07

(57) ABSTRACT

The present invention is related to micro-motion machine and micro-element fabricating machine using a 3-degree-of-freedom parallel mechanism. A micro-motion machine achieves a 3-degree-of-freedom micro movement by connecting two arms connected to prismatic flexible joints respectively, adapted to conduct vertical movements, by revolute flexible joints, and one arm connected to another prismatic flexible joint, adapted to conduct vertical movements by universal joint, to a platform by universal joint. This micro-motion machine has a relatively simple and inexpensive construction, high stiffness, and high accuracy, while exhibiting reduced inertia. Where the parallel mechanism is applied to micro-element fabricating machines, and a tool device or workpiece table is positioned at the platform of the parallel mechanism to perform a desired one of cutting, electro-discharging, and laser machining processes suitable for the machining of micro-elements, it is possible to design a micro-element fabricating machine having advantages of a relatively large workspace, especially high mobility, and an ability to fabricate three dimensional micro-elements having diverse shapes, along with the advantages of parallel mechanisms.

### BACKGROUND OF THE INVENTION

1. Field of the Invention

The present invention relates to high-precision machinery and high-precision manufacturing fields, and more particularly to a micro-motion machine and a micro-element fabricating machine using 3 degree of freedom parallel mechanism.

2. Description of the Related Art

Recent progress in control and fabrication technologies of microstructures has enabled the development of small machines. “Micro-machine” is the generic term for very small machines of a size of millimeters or less, for example, microrobots, micromotors, microsensors, micropumps, etc. For use of such micro-machines to become widespread, development of fabrication technologies for high-precision machines is greatly required.

The concept of the “microfactory” consisting of desktop micro machines has been established, on the basis of a determination that it is very advantageous in terms of energy, materials, space, and costs to fabricate micro mechanical elements using micro-machines, as compared to the case in which such micro mechanical elements are conventionally fabricated using macro-machines. In such a “microfactory”, microlathes, micro-milling machines, micro-press machines, micro-transfer machines form production lines for producing micro mechanical elements within a space having an area substantially equal to a desktop area.

In order to implement a “microfactory”, the demand for technologies for fabricating parts of individual micro machines included in the microfactory, and technologies capable of accurately controlling operations of micro machines, has been greatly increased. Meanwhile, it has been found that there is a limitation in developing micro machines by simply scaling down the size of existing lathes, machining centers, and milling machines.

In order to overcome such a limitation, attempts have been made to apply, to micro machines, a parallel mechanism for which a number of research efforts have been made to enable an application of the parallel mechanism to a high-precision positioning mechanism because the parallel mechanism has a high accuracy, high stiffness, simple structure, and high mobility. For a conventional parallel mechanism applied to high-precision positioning mechanisms, there is a 6-degree-of-freedom parallel mechanism consisting of 6 extendable links, as disclosed in U.S. Pat. Nos. 4,819,496, 5,476,357, 5,511,931, or 6,327,026. However, there are difficulties in mechanically analyzing and designing such a 6-degree-of-freedom parallel mechanism. Also, there are problems of a relatively small workspace, and a low mobility.

FIG. 1 shows a perspective view illustrating a 3-degree-of-freedom parallel mechanism with simple structure and high mobility (Xin-Jun Liu, et al., On the Analysis of a New Spatial Three Degrees of Freedom Parallel Manipulator, IEEE Transactions on Robotics and Automation, Vol.17, No.6, pp.959-968, 2001).

As shown in FIG. 1, the 3-degree-of-freedom parallel mechanism includes three sliders 8, 10, and 12 each adapted to perform a rectilinear movement, that is, a translation, along an associated one of three vertically-standing columns 5, 6, and 7, three arms 1, 2, and 3 each connected at one end thereof to an associated one of the sliders 8, 10, and 12, and a platform 4. The first and second arms 1 and 2 have the identical chains. The first and second arms 1 and 2 are connected at one-side ends thereof to the platform 4 by means of universal (or spherical) joints 17 and 15, respectively, while being connected at the other-side ends thereof to the sliders 8 and 10 by means of revolute joints 9 and 10, respectively. The third arm 3 consists of a planar parallelogram having four links connected by revolute joints. The third arm 3 is connected at one shorter link thereof to the platform 4 by means of revolute joints 20, while being connected at the other shorter link to the slider 12 by means of revolute joints 13. Each one of the universal joints 15 and 17 connected to the platform 4 may be replaceable by two revolute joints arranged to be orthogonal to each other. The universal joints 15 and 17 may be also replaced by two spherical joints.

The 3-degree-of-freedom parallel mechanism can be driven by actuators for enabling the sliders 8, 10, and 12 to be movable with respect to the columns 5, 6, and 7.

Now, the 3-degree-of-freedom movement of the parallel mechanism having the above described configuration while being equipped with the actuator will be described in detail.

Each of the first and second arms 1 and 2 is connected at an upper end thereof to an associated one of the first and second columns 5 and 6 by a prismatic joint movable rectilinearly with respect to a z-axis and a revolute joint 9 or 10 rotatable about x-axis. Each of the first and second arms 1 and 2 is connected at a lower end thereof to the platform 4 by the associated universal joint 17 or 15 rotatable about the x-axis and y-axis. Accordingly, each of the first and second arms 1 and 2 is constrained with the translation along the x-axis and the rotation about the z-axis.

As described above, the third arm 3 is a planar four-bar parallelogram. The third arm 3 is connected at an upper end thereof to the third column 7 by prismatic joints movable rectilinearly with respect to the z-axis and revolute joints 13 rotatable about the y-axis, while being connected at a lower end thereof to the platform 4 by revolute joints 20 rotatable about the y-axis. Accordingly, the third arm 3 is constrained with the rotations about the z-axis and x-axis.

In accordance with a combination of vertical translations conducted by the sliders 8, 10, and 12 to which the first, second and third arms are connected, respectively, the platform 4 is limited in its translation along the x-axis, and its rotations about the x-axis and z-axis, while being allowed to conduct translation along the y-axis and z-axis, and rotation about the y-axis. The rotation about the y-axis can be ±50° in a workspace.

### SUMMARY OF THE INVENTION

The present invention has been made in view of the above mentioned problems involved with the related art, and an object of the invention is to provide a micro-motion machine having a high accuracy, based on the 3-degree-of-freedom parallel mechanism which achieves an easy mechanical analysis thereof and an easy design thereof while having a high mobility.

Another object of the invention is to provide a micro-element fabricating machine having a high accuracy, and a large workspace while being capable of fabricating micro-elements of diverse structures based on the 3-degree-of-freedom parallel mechanism which achieves an easy mechanical analysis thereof and an easy design thereof while having a high mobility.

In accordance with one aspect, the present invention provides a micro-motion machine using the 3-degree-of-freedom parallel mechanism comprising: three prismatic flexible joints each movable vertically, three arms each connected at one end thereof to an associated one of the prismatic flexible joints, and a platform connected to other ends of the arms, wherein first and second ones of the three arms are connected at one ends to the upper ends of first and second ones of the three prismatic flexible joints by revolute flexible joints respectively, while being connected at other ends to the bottom of the platform by universal (or spherical) flexible joints respectively, and wherein a third arm being connected at one end to the side end of the platform by universal flexible joint, while being connected at other end to the side end of the elevated bar of an associated third one of the three prismatic flexible joints by a universal flexible joint, whereby the platform is able to conduct 3 degrees of freedom.

Preferably, the micro-motion machine using the 3-degree-of-freedom parallel mechanism further comprising: three translation actuators each adapted to drive an associated one of the three prismatic flexible joints to conduct a vertical translation operation; and a control unit for controlling the three translation actuators.

In accordance with one aspect, The present invention provides a 5-degree-of-freedom micro-element fabricating machine comprising: a 3-degree-of-freedom parallel mechanism comprising three sliders each movable along an associated one of three vertically-standing columns, three arms each connected at one end thereof to an associated one of the sliders, and a platform connected to respective other ends of the sliders, wherein first and second ones of the three arms are connected to the platform by universal (or spherical) joints, respectively, while being connected to associated first and second ones of the three sliders by revolute joints, respectively, and wherein a third one of the three arms comprising a planar four-bar parallelogram, the third arm being connected to the platform by revolute joints, while being connected to an associated third one of the three sliders by a revolute joint, whereby the platform is able to conduct a 3 degree-of-freedom; a tool device installed on the platform; and a workpiece table arranged beneath the platform, the workpiece table being able to conduct a rotation about a desired axis and a translation along a desired axis.

Preferably, the micro-element fabricating machine further comprises three translation actuators each adapted to drive an associated one of the three sliders to conduct a translation operation along the column associated with the associated slider; a rotation actuator adapted to drive the workpiece table to conduct the rotation thereof, a translation actuator adapted to drive the workpiece table to conduct the translation thereof, and a control unit for controlling the five actuators and a tool installed on the tool device.

In accordance with another aspect, the present invention provides a 5-degree-of freedom micro-element fabricating machine comprising: a 3-degree-of-freedom parallel mechanism comprising three sliders each movable along an associated one of three vertically-standing columns, three arms each connected at one end thereof to an associated one of the sliders, and a platform connected to respective other ends of the sliders, wherein first and second ones of the three arms are connected to the platform by universal (or spherical) joints, respectively, while being connected to associated first and second ones of the three sliders by revolute joints, respectively, and wherein a third one of the three arms comprising a planar four-bar parallelogram, the third arm being connected to the platform by revolute joints, while being connected to an associated third one of the three sliders by a revolute joint, whereby the platform is able to conduct a 3 degree-of-freedom; a workpiece table arranged above the platform of the 3-degree-of-freedom parallel mechanism; and a tool device provided with a tool for machining a workpiece laid on the workpiece table, the tool device being able to conduct a rotation about a desired axis and a translation along a desired axis.

Preferably, the micro-element fabricating machine further comprises three translation actuators each adapted to drive an associated one of the three sliders to conduct a translation operation along the column associated with the associated slider, a rotation actuator adapted to drive the tool device to conduct the rotation thereof, a translation actuator adapted to drive the tool device to conduct the translation thereof, and a control unit for controlling the five actuators and the tool installed on the tool device.

### BRIEF DESCRIPTION OF THE DRAWINGS

The above objects, and other features and advantages of the present invention will become more apparent after a reading of the following detailed description when taken in conjunction with the drawings, in which:

FIG. 1 is a perspective view illustrating a 3-degrees-of-freedom parallel mechanism that is adapted to the present invention;

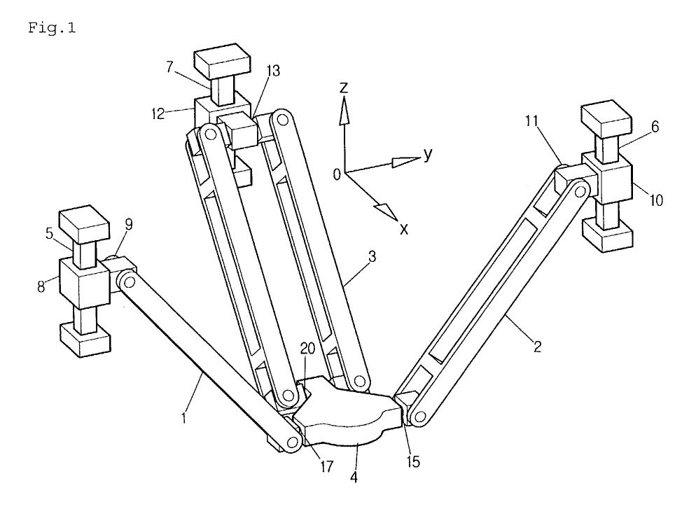

FIG. 2 shows a perspective view illustrating a micro-motion machine according to the present invention, which is implemented using flexible joints;

FIG. 3 shows a perspective view illustrating a first embodiment of a micro-element fabricating machine according to the present invention;

FIG. 4 shows a perspective view illustrating a second embodiment of a micro-element fabricating machine according to the present invention; and

FIG. 5 is a schematic view illustrating a design specification of the parallel mechanism according to the present invention.

### DESCRIPTION OF THE PREFERRED EMBODIMENTS

Now, preferred embodiments of the present invention will be described in detail with reference to the annexed drawings.

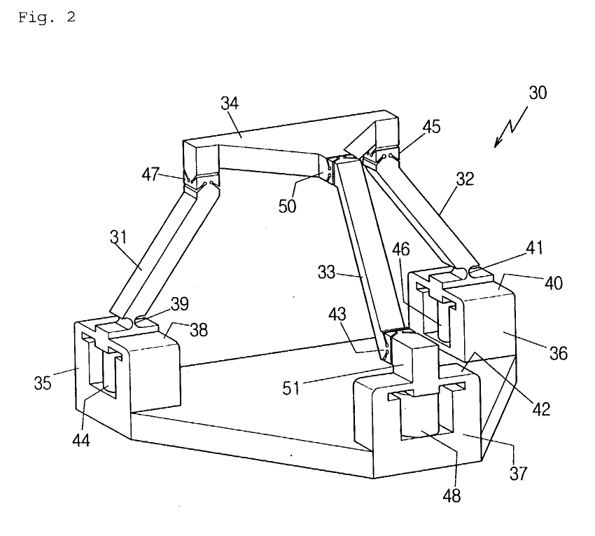

FIG. 2 shows a perspective view illustrating micro-motion machine 30 in accordance with the present invention, which is implemented using flexible joints.

As shown in FIG. 2, a micro-motion machine 30 using the 3-degree-of-freedom parallel mechanism comprises three prismatic flexible joints 38, 40, and 42 each movable vertically, three arms 31, 32, and 33 each connected at one end thereof to an associated one of the prismatic flexible joints 38, 40, and 42, and a platform 34 connected to other ends of the arms 31, 32, and 33.

First and second arms 31 and 32 are connected at one ends to the upper ends of first and second prismatic flexible joints 38 and 40 by revolute flexible joints 39 and 41 respectively, while being connected at other ends to the bottom of the platform 34 by universal flexible joints (or spherical flexible joints) 45 and 47 respectively.

A third arm 33 is connected at one end to the side end of the platform 34 by universal flexible joint 50, while being connected at other end to the side end of the elevated bar 51 of third prismatic flexible joint 42 by a universal flexible joint 43.

The micro-motion machine 30 using 3-degree-of-freedom parallel mechanism according to present invention further comprises three translation actuators 44, 46, and 48 each adapted to drive an associated one of the three prismatic flexible joints 38, 40, and 42 to conduct a vertical translation operation, and a control unit (not shown) for controlling the three translation actuators 44, 46, and 48.

It is desirable to use a piezoelectric element as an actuator because the motion of the micro-motion machine 30 is carried out on the scale of microns (μm). The piezoelectric element has characteristics suitable for the actuator of the micro-machine because it can achieve a precise control with an accuracy of several tens of nanometers, and a rapid response speed of several tens of nanoseconds. The only problem is a limited stroke, that is, a small longitudinal displacement of about 0.1% with respect to the length of the piezoelectric element. In order to overcome such a small displacement, a laminated structure of piezoelectric elements has been used. A displacement increasing mechanism has also been used.

In accordance with the present invention, piezoelectric elements 44, 46, and 48 are provided at respective columns 35, 36, and 37, as shown in FIG. 2. In accordance with the extension or retraction of the piezoelectric elements 44, 46, and 48, prismatic flexible joints 38, 40, and 42 are vertically moved. As a control unit (not shown) controls the vertical movement of each prismatic flexible joint, a 3-degrees-of-freedom movement of the platform 34 is achieved.

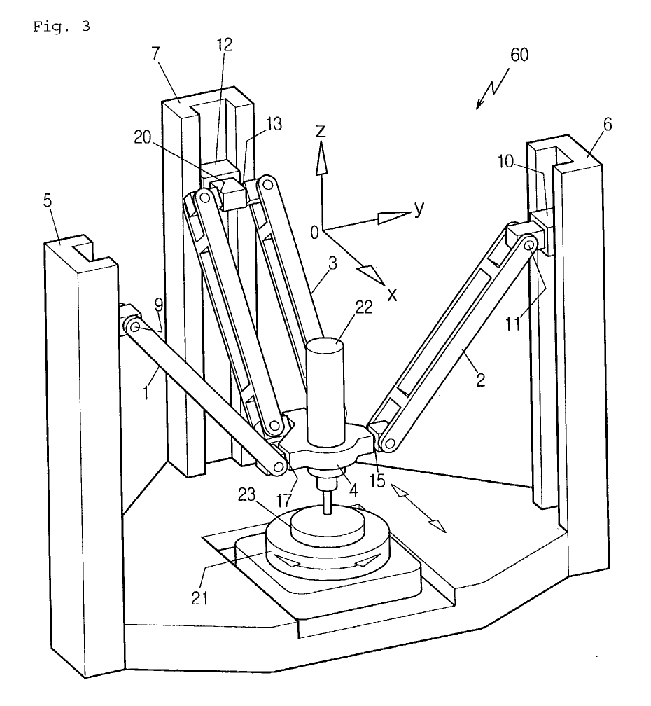

FIG. 3 shows a perspective view illustrating a first embodiment of a micro-element fabricating machine 60 according to the present invention.

As shown in FIG. 3, the micro-element fabricating machine of the first embodiment 60 is configured using the above described 3-degree-of-freedom parallel mechanism, in order to fabricate micro-elements. A tool device 22 is installed on the platform 4 of the 3-degree-of-freedom parallel mechanism. A workpiece table 21 is arranged beneath the platform 4. The workpiece table 21 can conduct a rotation about the z-axis, and a translation along the x-axis, as indicated by arrows in FIG. 3.

The micro-element fabricating machine 60 of the first embodiment has 5-degree-of-freedom in that the tool can conduct a movement of 3-degree-of-freedom by virtue of the parallel mechanism, and the workpiece table 21 can conduct a movement of two-degree-of-freedom, that is, a translation in forward and backward directions and a rotation.

In order to drive the micro-element fabricating machine 60 of the first embodiment, it is necessary to use five actuators, that is, three actuators for driving the sliders 8, 10, and 12 of the 3-degree-of-freedom parallel mechanism to conduct translations, one actuator for driving the workpiece table 21 to conduct a rotation, and one actuator for driving the workpiece table 21 to conduct a translation. The five actuators, and the tool mounted to the tool device 22 are controlled by a control unit (not shown), so that a workpiece 23 firmly held by the workpiece table 21 is fabricated into a micro-element having a three dimensional shape.

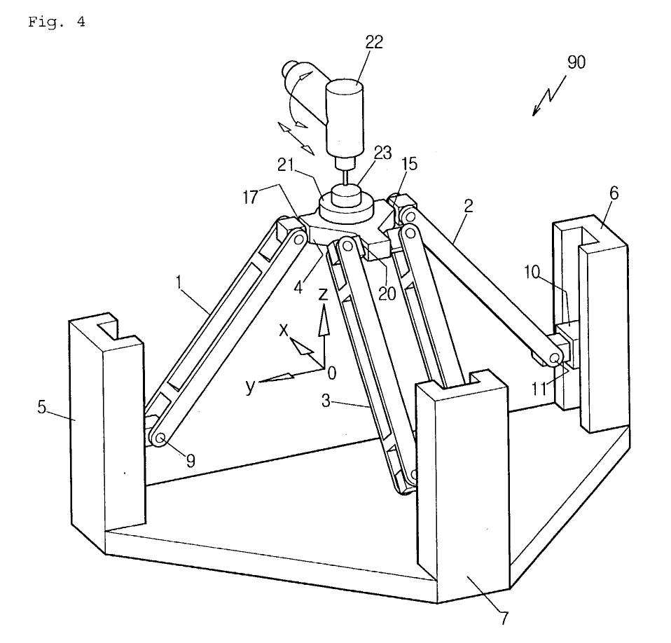

FIG. 4 shows a perspective view illustrating a second embodiment of a micro-element fabricating machine 90 according to the present invention.

As shown in FIG. 4, the micro-element fabricating machine 90 of the second embodiment is configured using the above described 3-degree-of-freedom parallel mechanism, in order to fabricate micro-elements, similarly to the first embodiment of FIG. 3. In accordance with the second embodiment, however, the 3-degree-of-freedom parallel mechanism is installed in an inverted state, and the workpiece table 21 is arranged on the platform 4. The tool device 22 is arranged above the workpiece table 21 so that it can conduct translation along the x-axis and rotation about the x-axis.

The micro-element fabricating machine 90 of the second embodiment has 5-degree-of-freedom in that the workpiece table 21 can conduct a movement of 3-degree-of-freedom by virtue of the parallel mechanism, and the tool device 22 can conduct a movement of two-degree-of-freedom, that is, translation along the x-axis and rotation about the x-axis.

In order to drive the micro-element fabricating machine 90 of the second embodiment, it is necessary to use five actuators, that is, three actuators for driving the sliders of the 3-degree-of-freedom parallel mechanism to conduct translations, one actuator for driving the workpiece table 21 to conduct a rotation, and one actuator for driving the workpiece table 21 to conduct a translation. The five actuators, and the tool mounted to the tool device 22 are controlled by a control unit (not shown), so that a workpiece 23 firmly held by the workpiece table 21 is fabricated into a micro-element having a three dimensional shape.

The actuators of the micro-element fabricating machine 60 and 90 according to the present invention may include a motor operatively connected to a gear or ball screw, a linear motor, piezoelectric element, or the like, that are suitable for precise motion control.

There is no limitation on the fabricating method usable in the micro-element fabricating machine 60 and 90 according to the present invention. Also, diverse fabricating elements according to the used fabricating method may be mounted to the tool device 22 of the micro-element fabricating machine according to each of the first and second embodiments 60 and 90. For example, a cutting tool or spindle enabling a mechanical fabrication, an optical system included in a laser machining device, or an electrode for electro-discharge machining (EDM) may be mounted.

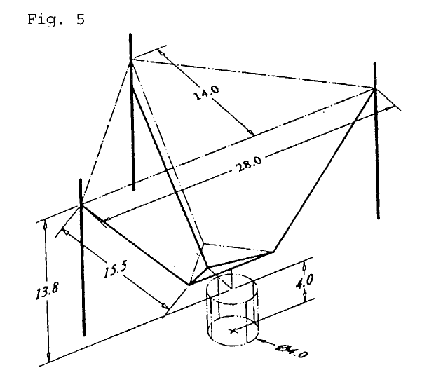

The factor to be necessarily taken into consideration in designing a machine using a parallel mechanism is that the workspace should have no singularity. The same factor is applied to the micro-element fabricating machine according to the present invention. For example, the micro-element fabricating machines has the following design conditions: 1) the workspace should have no singularity; 2) the workspace should have a size of 4 mm (diameter)×4 mm (height) or more; 3) the 3-degree-of-freedom parallel mechanism should have a size shown in FIG. 5, that is, a distance of 28.0 mm between the first and second columns, a length of 14.0 mm of the vertical line extending to the horizontal line connecting the first and second columns; a length of 15.5 mm of each of the first and second arms, and a distance of 13.8 mm from the level at which the first or second arm is fixed to the associated column when the parallel mechanism is positioned at the origin of the machine, to the upper end of the workspace; and 4) the platform should be able to rotate about the y-axis within a range of ±50° in a workspace. Based on an inverse kinematics and Jacobian analysis conducted for the above described design conditions, the strokes of the sliders 8 and 10 are determined to range from −6.2 mm to 1.6 mm with respect to the z-axis, and the stroke of the slider 2 is determined to range from −12.3 mm to 1.6 mm with respect to the z-axis. Therefore, it is possible to prevent the workspace from having any singularity where the sliders 8, 10, and 12 are driven within the ranges given under the above-described design conditions.

As apparent from the above description, the present invention provides micro-element fabricating machines based on a 3-degree-of-freedom parallel mechanism

The 3-degree-of-freedom parallel mechanism not only has the advantages of parallel mechanisms, that is, high stiffness and high positional accuracy and precision, but also have advantages in that diverse works can be performed because the platform of the parallel mechanism can rotate with ±50° tilting angle in a workspace, and the parallel mechanism has a simple construction.

Since the micro-element fabricating machine uses the 3 degree-of-freedom parallel mechanism having the above described advantages, it has the advantages of the parallel mechanism, that is, high stiffness and high positional accuracy and precision, and in that diverse works can be achieved because the platform of the parallel machine can rotate with ±50° tilting angle in a workspace, and the parallel machine has a simple construction. Accordingly, it is possible to precisely fabricate micro-elements having a three dimensional shape while providing a large workspace without any singularity in the workspace. By virtue of the simple construction, there is an advantage of an easy design.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A micro-motion machine using a 3-degree-of-freedom parallel mechanism comprising:
three prismatic flexible joints each movable vertically, three arms each connected at one end thereof to an associated one of the prismatic flexible joints, and a platform connected to other ends of the arms,
wherein first and second ones of the three arms are connected at one ends to the upper ends of first and second ones of the three prismatic flexible joints by revolute flexible joints respectively, while being connected at other ends to the bottom of the platform by universal (or spherical) flexible joints respectively, and
wherein a third arm being connected at one end to the side end of the platform by universal flexible joint, while being connected at other end to the side end of the elevated bar of an associated third one of the three prismatic flexible joints by a universal flexible joint, whereby the platform is able to conduct a 3-degree-of-freedom.

2. The micro-motion machine using a 3-degree-of-freedom parallel mechanism according to claim 1, further comprising:
three translation actuators each adapted to drive an associated one of the three prismatic flexible joints to conduct a vertical translation operation; and
a control unit for controlling the three translation actuators.

3. A micro-element fabricating machine comprising:
a 3-degree-of-freedom parallel mechanism comprising
three sliders each movable along an associated one of three vertically-standing columns, three arms each connected at one end thereof to an associated one of the sliders, and a platform connected to respective other ends of the sliders,
wherein first and second ones of the three arms are connected to the platform by universal (or spherical) joints, respectively, while being connected to associated first and second ones of the three sliders by revolute joints, respectively, and
wherein a third one of the three arms comprising a planar four-bar parallelogram, the third arm being connected to the platform by revolute joints, while being connected to an associated third one of the three sliders by a revolute joint, whereby the platform is able to conduct 3 threes of freedom;
a tool device installed on the platform; and
a workpiece table arranged beneath the platform, the workpiece table being able to conduct a rotation about a desired axis and a translation along a desired axis.

4. The micro-element fabricating machine according to claim 3, further comprising:
three translation actuators each adapted to drive an associated one of the three sliders to conduct a translation operation along the column associated with the associated slider;
a rotation actuator adapted to drive the workpiece table to conduct the rotation thereof;
a translation actuator adapted to drive the workpiece table to conduct the translation thereof; and
a control unit for controlling the five translation actuators and a tool installed on the tool device.

5. A micro-element fabricating machine comprising:
a 3-degree-of-freedom parallel mechanism comprising
three sliders each movable along an associated one of three vertically-standing columns, three arms each connected at one end thereof to an associated one of the sliders, and a platform connected to respective other ends of the sliders,
wherein first and second ones of the three arms are connected to the platform by universal (or spherical) joints, respectively, while being connected to associated first and second ones of the three sliders by revolute joints, respectively, and
wherein a third one of the three arms comprising a planar four-bar parallelogram, the third arm being connected to the platform by revolute joints, while being connected to an associated third one of the three sliders by a revolute joint, whereby the platform is able to conduct a 3-degree-of-freedom;
a workpiece table arranged above the platform of the 3-degree-of-freedom parallel mechanism; and
a tool device provided with a tool for machining a workpiece laid on the workpiece table, the tool device being able to conduct a rotation about a desired axis and a translation along a desired axis.

6. The micro-element fabricating machine according to claim 5, further comprising:
three translation actuators each adapted to drive an associated one of the three sliders to conduct a translation operation along the column associated with the associated slider;
a rotation actuator adapted to drive the tool device to conduct the rotation thereof;
a translation actuator adapted to drive the tool device to conduct the translation thereof; and
a control unit for controlling the five translation actuators and the tool installed on the tool device.
